(19) United States
(12) Patent Application Publication
(10) Pub. No.: US 2021/0383034 A1
(43) Pub. Date: Dec. 9, 2021

(54) AUTOMATED STEEL STRUCTURE DESIGN SYSTEM AND METHOD USING MACHINE LEARNING

(71) Applicant: Hyundai Engineering Co., Ltd., Seoul (KR)

(72) Inventor: Jeong Won Jo, Seoul (KR)

(73) Assignee: Hyundai Engineering Co., Ltd., Seoul (KR)

(21) Appl. No.: 17/121,518

(22) Filed: Dec. 14, 2020

(30) Foreign Application Priority Data
Jun. 5, 2020 (KR) 10-2020-0068314

(51) Int. Cl. G06F 30/13; G06N 20/20; G06N 5/04

(52) U.S. Cl. CPC G06F 30/13; G06N 5/04; G06N 20/20

(57) ABSTRACT

The present disclosure may relate to a steel structure design system including an automated design unit having a basic structural analysis model for a steel structure generated by a structural analysis program, the automated design unit being configured to output automatic design result values under an input basic design condition, a machine learning unit configured to machine-learn the automatic design result values to generate a prediction model for the steel structure, and an extended database formed as the result of storing prediction result values under an extended design condition more than the automatic design result values output by the prediction model.

### CROSS-REFERENCE TO RELATED APPLICATION

This application claims, under 35 U.S.C. § 119(a), the benefit of priority to Korean Patent Application No. 10-2020-0068314 filed on Jun. 5, 2020, the entire contents of which are incorporated herein by reference.

### BACKGROUND

### (a) Technical Field

The present disclosure relates to civil engineering technology, and more particularly to automated steel structure design technology using machine learning.

### (b) Background Art

A structure database possessed through business conduction so as to be used for reference at the time of quantity calculation and implementation design in bidding business or execution business has limitations in considering characteristics of all structures. Structure design and quantity calculation that cannot use the database depends on subjectivity of a designer. In addition, whenever an additional database is constructed, outsourcing expenses are incurred, and it is difficult to rapidly construct the database. In the case in which data about a new environment or an additional steel structure are required, therefore, it is necessary to provide technology capable of automatically designing the data and selecting the optimum structure such that additional expenses and M/H are not incurred.

As an example of the prior art utilizing machine learning in designing architecture, Japanese Patent Application Publication No. 2019-75062, discloses a construction of using machine learning in determination of similarity between a building to be designed and existing design data in order to use the existing design data.

### PRIOR ART DOCUMENT

### Patent Document

(Patent Document 1) Japanese Patent Application Publication No. 2019-75062 entitled DESIGN SUPPORTING APPARATUS AND DESIGN SUPPORTING METHOD (2019.05.16)

The above information disclosed in this Background section is provided only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with the prior art.

It is an object of the present invention to provide a steel structure design system and method using machine learning.

It is another object of the present invention to provide a steel structure design system and method using machine learning capable of selecting the optimum structure under various design conditions.

The objects of the present invention are not limited to those described above, and other unmentioned objects of the present invention will be clearly understood by a person of ordinary skill in the art (hereinafter referred to as an “ordinary skilled person”) from the following description.

In order to accomplish the objects, in an aspect, the present invention provides a steel structure design system including an automated design unit having a basic structural analysis model for a steel structure generated by a structural analysis program, the automated design unit being configured to output automatic design result values under an input basic design condition, a machine learning unit configured to machine-learn the automatic design result values to generate a prediction model for the steel structure, and an extended database formed as the result of storing prediction result values under an extended design condition more than the automatic design result values output by the prediction model.

In another aspect, the present invention provides a steel structure design method including an automated design unit generation step of generating an automated design unit having a basic structural analysis model for a steel structure generated by a structural analysis program, the automated design unit being configured to output automatic design result values under an input basic design condition, a prediction model generation step of machine-learning the automatic design result value data to generate a prediction model for the steel structure, and an extended database construction step of storing prediction result values more than the automatic design result values output by the prediction model in a memory device to construct an extended database.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a block diagram showing the construction of a steel structure design system using machine learning according to an embodiment of the present invention; and

FIG. 2 is a flowchart schematically illustrating a steel structure design method using machine learning according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes, will be determined in part by the particular intended application and use environment.

In the figures, reference numbers refer to the same or equivalent parts of the present invention throughout the several figures of the drawing.

### DETAILED DESCRIPTION

Hereinafter, the construction and operation of embodiments of the present invention will be described in detail with reference to the accompanying drawings.

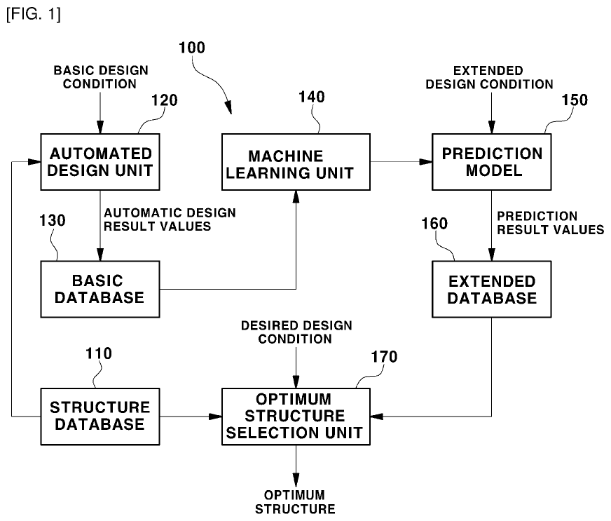

FIG. 1 is a block diagram showing the construction of a steel structure design system using machine learning according to an embodiment of the present invention. Referring to FIG. 1, the steel structure design system 100 using machine learning according to the embodiment of the present invention includes a structure database 110 configured to store data about a plurality of structure types classified based on shape of a steel structure, an automated design unit 120 having a basic structural analysis model generated by a structural analysis program, the automated design unit being configured to receive the data about the structure types from the structure database 110 and to output automatic design result values under an input basic design condition, the structure database 110 being configured to provide the stored structure type data to the automated design unit 120, a basic database 130 configured to store the automatic design result values output by the automated design unit 120 in the form of a database, a machine learning unit 140 configured to machine-learn the automatic design result values stored in the basic database 130, a prediction model 150 generated by machine learning of the machine learning unit 140, the prediction model being configured to output prediction result values under an extended design condition, an extended database 160 configured to store the prediction result values output by the prediction model 150 in the form of a database, and an optimum structure selection unit 170 configured to select the optimum structure satisfying a desired design condition from among the plurality of structure types stored in the structure database 110 using the data stored in the extended database 160. Hereinafter, each of the structure database 110, the automated design unit 120, the basic database 130, the machine learning unit 140, the prediction model 150, the extended database 160, and the optimum structure selection unit 170 constituting the steel structure design system 100 using machine learning will be described in detail.

The structure database 110 stores data about a plurality of structure types classified based on shape of a steel structure. In this embodiment, it is assumed that data about a total of 20 structure types, namely 9 warehouse structure types and 11 compressor shelter structure types, are stored in the structure database 110. The data about the structure types are provided to the automated design unit 120 and the optimum structure selection unit 170 so as to be used in calculating automatic design result values and selecting the optimum structure.

The automated design unit 120 has a basic structural analysis model generated by a structural analysis program, receives the data about the structure types from the structure database 110, and outputs automatic design result values (the amount of steel) under an input basic design condition. The structural analysis program used in this embodiment is STAAD by Bentley Company. OpenSTAAD is an application programming interface (API) used in STAAD, and interconnects STAAD and a computer programming language. Code written in the computer programming language through OpenSTAAD is transmitted to STAAD, and the basic structural analysis model is automatically generated. In this embodiment, it is assumed that Visual Basic is used as the computer programming language. However, the present invention is not limited thereto. The automated design unit 120 outputs automatic design result values, which are structural analysis results under various basic design conditions, using the basic structural analysis model. The automated design unit 120 receives information about a plurality of structure types classified based on shape of a steel structure from the structure database 110. Consequently, the automated design unit 120 outputs automatic design result values under a basic design condition based on structure type of the steel structure. The automatic design result values output by the automated design unit 120 are stored in the basic database 130 in the form of a database. In this embodiment, it is assumed that the number of automatic design result value data for 9 warehouse structure types is 756 and the number of automatic design result value data for 11 compressor shelter structure types is 924, i.e. the total number of automatic design result value data is 1680. Table 1 below shows user-defined design condition input data.

TABLE 1

| Category | Parameter | Input Data | Description |
|---|---|---|---|
| GENERAL | W | Building Width (m) | |
| | C | Distance between | Variable Span can be input |
| | | Pillars (m) | using Space (Ex: 6 7 5) |
| | B | Number of Bays (EA) | |
| | H | Building Height (m) | Height from Pedestal Top to |
| | | | Eave |
| | CRANE | Crane Capacity(Ton) | 3 to 100 Ton |
| | CRANE GIRDER | Crane Girder Section | Japanese, American, |
| | SIZE | (Select) | European are selectable. |
| | TYPE OF | Building Type (Select) | 9 Warehouse types (without |
| | STRUCTURE | | Crane) and 11 Compressor |
| | | | types (with Crane) are |
| | | | selectable. |
| | SECTION | Section Profile | Japanese, American, |
| | PROFILE | (Select) | European are selectable. |
| GENERAL | Dead Load-Wall | kN/m² | |
| LOAD | Dead Load-Roof | kN/m² | |
| | Roof Live Load | kN/m² | |
| WIND LOAD | Basic Wind Speed | m/s | |
| (ASCE 7-10) | (V) | | |
| | Topographic | 1.00, 1.05, 1.09, 1.11, | |
| | Factor (Kzt) | 1.18, 1.21, 1.27, 1.41 | |
| | Directionality | Factor | |
| | Factor (Kd) | | |
| | Exposure | B, C, D | |
| | Category | | |
| SEISMIC | Site Class | A, B, C, D, E, F | |
| LOAD | Importance Factor | Factor | |
| (ASCE 7-10) | SDS | SDS | Design response acceleration |
| | | | parameter at 0.2 periods |
| | | | (SDS = 2/3 SMS): |
| | SD1 | SD1 | Design response acceleration |
| | | | parameter at 1.0 periods |
| | | | (SDS = 2/3 SM1): |
| DETAIL | SLOPE | Slope: 10 | Wind load is input in state of |
| PARAMETER | | | being divided as Y- and Z-axis |
| | | | loadings in direction |
| | | | perpendicular to roof member |
| | | | depending on slope. |
| | FYLD | Yield strength (kN/m²) | |
| | Deflection Limit | Deflection Limit | Combined relative deflection |
| | | | in X, Y, and Z directions |
| | Deflection | Deflection Limit of | Calculation of Crane Girder |
| | Limit(Crane) | Crane Girder | must be separately calculated. |
| | Sway Limit | Sway Limit | |
| | Sway Limit(Crane | Sway Limit of Column | |
| | Bay) | in Crane Bay | |
| | CG Location | Location of Crane | |
| | | Girder and Distance | |
| | | from Eave (m) | |
| | Truss Depth | Truss Depth (m) | |
| | Support Condition | FIXED, PINNED | Support Condition of Main |
| | | | Column |
| | Main Column | Height, Width(mm) | RC |
| | SUB Column | Height, Width(mm) | RC |
| | TIE GIRDER | Height, Width(mm) | RC |
| TARGET | Main Column | Main Column Design | Member Group: SC |
| RATIO | | Target Ratio | |
| | Sub Column | Sub Column Design | Member Group: WC1, WC2 |
| | | Target Ratio | |
| | Roof Girder | Roof Girder Design | Member Group: RSG |
| | | Target Ratio | |
| | Roof Beam | Roof Beam Design | Member Group: RSB1, RSB2 |
| | | Target Ratio | |
| | Middle Beam | Middle Beam Design | Member Group: MSB1, MSB2 |
| | | Target Ratio | |
| | Horizontal Brace | Horizontal Brace | Member Group: HB |
| | | Design Target Ratio | |
| | Vertical Brace | Vertical Brace Design | Member Group: VB, VB2, |
| | | Target Ratio | STVB |
| | Crane | Crane Design Target | Member Group: CG, CB, CHB |
| | | Ratio | |
| | TRUSS TOP | TRUSS TOP Design | Member Group: STT |
| | | Target Ratio | |
| | TRUSS BOT | TRUSS BOTTOM | Member Group: STB |
| | | Design Target Ratio | |
| | TRUSS VERT | TRUSS VERTICAL | Member Group: STV |
| | | Design Target Ratio | |
| | TRUSS DIA | TRUSS DIAGONAL | Member Group: STD |
| | | Design Target Ratio | |

The automatic design result value data output by the automated design unit 120 are stored in the basic database 130 in the form of a database. In this embodiment, it is assumed that 1680 automatic design result value data output by the automated design unit 120 are stored in the basic database 130. The automatic design result value data stored in the basic database 130 are provided to the machine learning unit 140 so as to be used in machine learning.

The machine learning unit 140 machine-learns the automatic design result values stored in the basic database 130 to generate a prediction model 150 for a steel structure. In this embodiment, it is assumed that stacking ensemble model technique is used to improve accuracy in machine learning prediction. In this embodiment, the automatic design result values stored in the basic database 130 were evaluated using Linear Regression, Support Vector Regressor, Linear Support Vector Regressor, DecisionTree Regressor, XGBoost Regressor, LightGBM Regressor, Random Forest Regressor, GradientBoosting Regressor, Ridge Regressor, Lasso Regressor, and ElasticNet Regressor models in order to measure performance thereof.

Performance evaluation was performed through cross-validation using the following evaluation indices (MAE, RMSE, and R²).

MAE (Mean Absolute Error)

$$MAE = \frac{1}{2} {\sum }_{i = 1}^{n} \vert Yi - \hat{Y} i \vert$$

This is a value obtained by converting differences between actual values and prediction values into absolute values and averaging the same. MAE is inversely proportional to prediction accuracy.

RMSE (Root Mean Square Error)

$$RMSE = \sqrt{\frac{1}{n} {\sum }_{i = 1}^{n} {( Yi - \hat{Y} i )}^{2}}$$

This is a positive square root of a value (MSE) obtained by squaring the differences between actual values and prediction values and averaging the same. RMSE is inversely proportional to prediction accuracy.

R² (Coefficient of Determination)

$${R}^{2} = \frac{Prediction value variance}{Actual value variance}$$

This is the ratio of prediction value variance to actual value variance. As R² is closer to 1, prediction accuracy becomes higher.

Table 2 below shows the results of performance evaluation for respective models.

TABLE 2

| Model Name | MAE | RMSE | R² |
|---|---|---|---|
| DecisionTree Regressor | 5.545 | 8.877 | 0.937 |
| XGBoost Regressor | 4.261 | 8.329 | 0.944 |
| GradientBoosting Regressor | 4.410 | 8.226 | 0.948 |
| RandomForest Regressor | 4.366 | 7.088 | 0.960 |
| Linear Regression | 11.646 | 14.217 | 0.836 |
| Support Vector Regressor | 18.946 | 25.124 | 0.501 |
| Linear Support Vector Regressor | 10.633 | 14.742 | 0.828 |
| LightGBM Regressor | 18.195 | 22.488 | 0.601 |
| Ridge Regressor | 11.520 | 14.117 | 0.838 |
| Lasso Regressor | 11.295 | 13.972 | 0.841 |
| ElasticNet Regressor | 11.278 | 13.956 | 0.842 |
| Stacking Ensemble Model | 1.765 | 2.248 | 0.970 |

Prediction was performed again using Linear Support Vector Regressor as the final meta algorithm model based on data predicted using DecisionTree Regressor, XGBoost Regressor, RandomForest Regressor, and Gradient Boosting Regressor algorithms, performance of each of which was high as the result of performance evaluation, as individual prediction algorithm models. A stacking ensemble model having higher performance than the individual models may be generated through a series of prediction algorithm connection operations described above. The prediction model 150 is generated by the machine learning unit 140 using the stacking ensemble model technique.

The prediction algorithm and applied parameters used as the individual-based models and the final meta model in the stacking ensemble model in this embodiment will be described.

Individual-based model 1 (DecisionTree Regressor): DecisionTree is a process of automatically finding rules in data through learning and dividing the same into subsets according to an appropriate division criterion or division test. This process continues until no new prediction value is added due to division or the subsets have the same value as a target variable. Classification and regression class are present in DecisionTree. DecisionTree Regressor is applied to values having continuous target variables. Applied parameters are as follows.
min_sample_split: 3 (Minimum number of sample data to divide node)
max_depth: 4 (Maximum depth of DecisionTree)

Individual-based model 2 (GradientBoostinq Regressor): GradientBoosting is an algorithm corresponding to a Boosting series, among ensemble methods capable of performing classification and regression analysis. This is an algorithm of sequentially training and predicting several learners using Gradient Descent of finding a value in which the slope of a cost function (error) becomes the minimum and applying a weight to incorrectly predicted data to reduce (boosting) the error. Applied parameters are as follows.
n_estimators: 30 (Maximum number of subsets)
learning_rate: 0.1 (Learning rate whenever learning is performed)
max_depth: 3 (Maximum depth of subsets)

Individual-based model 3 (XGB Regressor): XGBoost (eXtra Gradient Boost) is a model based on Gradient Boost. Standard Gradient Boost has an overfitting regularization function capable of solving a problem in that machine learning is excessively performed (overfitting), whereby learning data exhibit high reliability, but reliability is reduced in prediction based on actual data. Applied parameters are as follows.
n_estimators: 100 (Maximum number of subsets)
learning_rate: 0.1 (Learning rate whenever learning is performed)
max_depth: 2 (Maximum depth of subsets)

Individual-based model 4 (RandomForest Regressor): RandomForest is an ensemble method of learning DecisionTree in numbers, which is used in a classification and regression problem. A data set is divided (Bootstrapping) so as to partially overlap each other, and overlapping individual data sets are learned using DecisionTree. The finally learned individual set is predicted and decided through voting, whereby it is possible to acquire a prediction value having higher reliability than in prediction of a single set. Applied parameters are as follows.
n_estimators: 100 (Number of DecisionTree)
max_depth: 7 (Maximum depth of DecisionTree subtree)

Final meta model (Linear Support Vector Regressor): After Individual-based models were stacked, a Support Vector Machine model exhibiting the best final coupling performance as the result of performance evaluation was selected as the final meta model. Support Vector Machine is a multi-purpose machine learning model that can be used in linear or nonlinear classification, regression, and abnormal value search. After being suggested in order to solve a classification operation first, Support Vector Machine was extended in order to solve a regression problem (SVR). The fundamental idea of this method is to provide the widest “road” between classes, and this is a method of reducing an error in order to maximally increase the margin between a decision boundary partitioning two classes and a sample. Applied parameters are as follows.
Epsilon: 2.0 (Margin, Width of road)

The prediction model 150 is generated by stacking ensemble model technique in the machine learning unit 140, and outputs prediction result values under an extended design condition. The prediction result values output by the prediction model 150 are stored in the extended database 160 in the form of a database. In this embodiment, it is assumed that the number of prediction result value data for 9 warehouse structure types is 12,572,469 and the number of prediction result value data for 11 compressor shelter structure types is 14,855,841, i.e. the total number of prediction result value data is 27,428,310. That is, 27,428,310 extended result value data are acquired through the prediction model 150 generated by the machine learning unit 140 using 1680 result value data acquired by the automated design unit 120.

The extended database 160 stores the prediction result value data output by the prediction model 150 in the form of a database. In this embodiment, it is assumed that 27,428,310 prediction result value data output by the prediction model 150 are stored in the extended database 160. The prediction design result value data stored in the extended database 160 are provided to the optimum structure selection unit 170 so as to be used in selecting the optimum structure.

The optimum structure selection unit 170 selects and outputs the optimum structure satisfying a desired design condition and having an estimated smallest amount of steel from among the plurality of structure types stored in the structure database 110 using tens of millions of prediction result value data stored in the extended database 160.

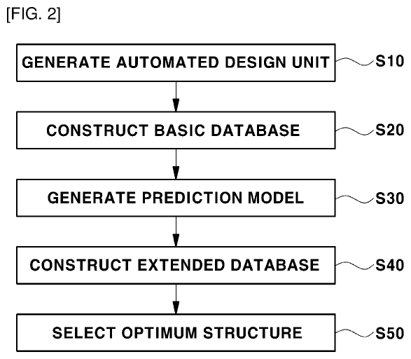

FIG. 2 is a flowchart schematically illustrating a steel structure design method using machine learning according to an embodiment of the present invention. The steel structure design method using machine learning shown in FIG. 2 uses the steel structure design system 100 using machine learning shown in FIG. 1. Consequently, the steel structure design method using machine learning according to the embodiment of the present invention will be described with reference to FIGS. 1 and 2. Referring to FIGS. 1 and 2, the steel structure design method using machine learning according to the embodiment of the present invention includes an automated design unit generation step (S10) of generating an automated design unit 120 configured to output automatic design result values under an input basic design condition, a basic database construction step (S20) of constructing a basic database 130 configured to store the automatic design result value data output by the automated design unit 120, a prediction model generation step (S30) of machine-learning the automatic design result values stored in the basic database 130 to generate a prediction model 150, an extended database construction step (S40) of constructing an extended database 160 configured to store the prediction result value data output by the prediction model 150, and an optimum structure selection step (S50) of selecting the optimum steel structure using the prediction result value data stored in the extended database 160.

In the automated design unit generation step (S10), an automated design unit 120 having a basic structural analysis model generated by a structural analysis program and configured to receive the data about the structure types from the structure database 110 and to output automatic design result values (the amount of steel) under an input basic design condition is generated. In this embodiment, code written in a computer programming language through OpenSTAAD is transmitted to STAAD and the basic structural analysis model is automatically generated, whereby the automated design unit generation step (S10) is performed. The automated design unit 120 outputs automatic design result values, which are structural analysis results under various basic design conditions, using the basic structural analysis model. The automated design unit 120 receives information about a plurality of structure types classified based on shape of a steel structure from the structure database 110. Consequently, the automated design unit 120 outputs automatic design result values under a basic design condition based on structure type of the steel structure. After the automated design unit 120 is generated in the automated design unit generation step (S10), the basic database construction step (S20) is performed.

In the basic database construction step (S20), the automatic design result value data output by the automated design unit 120 are stored in a memory device, whereby the basic database 130 is constructed. That is, the automatic design result value data output by the automated design unit 120 are stored in the basic database 130 in the form of a database.

In the prediction model generation step (S30), the automatic design result values stored in the basic database 130 are machine-learned, whereby the prediction model 150 is generated. A machine learning algorithm used in the prediction model generation step (S30) is identical to that described previously in connection with the machine learning unit 140 of FIG. 1. The prediction model 150 is generated by the machine learning unit 140 using the stacking ensemble model technique, and outputs output prediction result values under an extended design condition. The prediction result values output by the prediction model 150 are stored in the form of a database in the extended database construction step (S40).

In the extended database construction step (S40), the prediction result value data output by the prediction model 150 are stored in a memory device, whereby the extended database 160 is constructed. That is, the prediction result value data output by the prediction model 150 are stored in the extended database 160 in the form of a database.

In the optimum structure selection step (S50), the optimum structure selection unit 170 selects the optimum structure satisfying a desired design condition and having an estimated smallest amount of steel from among the plurality of structure types stored in the structure database 110 using the prediction result value data stored in the extended database 160.

As is apparent from the foregoing, the present invention is capable of accomplishing the object of the present invention described above. Specifically, the automatic design result values acquired by the automated design unit are learned through the machine learning algorithm, whereby the prediction model is generated, and design data are extended through the prediction model, whereby it is possible to select the optimum structure under various design conditions.

It will be apparent to a person of ordinary skill in the art that the present invention described above is not limited to the above embodiments and the accompanying drawings and that various substitutions, modifications, and variations can be made without departing from the technical idea of the present invention.

What is claimed is:

1. A steel structure design system using machine learning, the steel structure design system comprising:
an automated design unit having a basic structural analysis model for a steel structure generated by a structural analysis program, the automated design unit being configured to output automatic design result values under an input basic design condition;
a machine learning unit configured to machine-learn the automatic design result values to generate a prediction model for the steel structure; and
an extended database formed as a result of storing prediction result values under an extended design condition more than the automatic design result values output by the prediction model, wherein
the machine learning unit generates the prediction model using a stacking ensemble model technique, and
the stacking ensemble model technique uses DecisionTree Regressor, XGBoost Regressor, RandomForest Regressor, and Gradient Boosting Regressor algorithms as individual prediction algorithm models and uses Linear Support Vector Regressor as a final meta algorithm model.

2. A steel structure design system using machine learning, the steel structure design system comprising:
an automated design unit having a basic structural analysis model for a steel structure generated by a structural analysis program, the automated design unit being configured to output automatic design result values under an input basic design condition;
a machine learning unit configured to machine-learn the automatic design result values to generate a prediction model for the steel structure;
an extended database formed as a result of storing prediction result values under an extended design condition more than the automatic design result values output by the prediction model;
a structure database configured to store data about a plurality of structure types classified based on shape of the steel structure; and
an optimum structure selection unit configured to select an optimum structure satisfying a desired design condition and having an estimated smallest amount of steel using the prediction result value data stored in the extended database, wherein
the optimum structure selection unit selects an optimum structure type from among the plurality of structure types stored in the structure database.

3. A steel structure design method using machine learning, the steel structure design method being performed using a design system comprising: an automated design unit having a basic structural analysis model for a steel structure generated by a structural analysis program, the automated design unit being configured to output automatic design result values under an input basic design condition; a machine learning unit configured to machine-learn the automatic design result values to generate a prediction model for the steel structure; an extended database formed as a result of storing prediction result values under an extended design condition more than the automatic design result values output by the prediction model; and an optimum structure selection unit configured to select an optimum structure, the steel structure design method comprising:
a prediction model generation step of the machine learning unit machine-learning the automatic design result value data using a stacking ensemble model technique to generate the prediction model; and
an optimum structure selection step of the optimum structure selection unit selecting an optimum structure satisfying a desired design condition and having an estimated smallest amount of steel using the prediction result value data, wherein
the stacking ensemble model technique uses DecisionTree Regressor, XGBoost Regressor, RandomForest Regressor, and Gradient Boosting Regressor algorithms as individual prediction algorithm models and uses Linear Support Vector Regressor as a final meta algorithm model.

4. A steel structure design method using machine learning, the steel structure design method being performed using a design system comprising: a structure database configured to store data about a plurality of structure types classified based on shape of a steel structure; an automated design unit having a basic structural analysis model for the steel structure generated by a structural analysis program, the automated design unit being configured to output automatic design result values under an input basic design condition; a machine learning unit configured to generate a prediction model for the steel structure; an extended database formed as a result of storing prediction result values under an extended design condition more than the automatic design result values output by the prediction model; and an optimum structure selection unit configured to select an optimum structure, the steel structure design method comprising:
a prediction model generation step of the machine learning unit machine-learning the automatic design result value data to generate the prediction model; and
an optimum structure selection step of the optimum structure selection unit selecting an optimum structure satisfying a desired design condition and having an estimated smallest amount of steel using the prediction result value data from among the plurality of structure types stored in the structure database.
